(19) United States
(12) Patent Application Publication
(10) Pub. No.: US 2014/0246513 A1
(43) Pub. Date: Sep. 4, 2014

(54) Irrigation Device

(71) Applicant: Sawyer H. TERRELL, San Francisco, CA (US)

(72) Inventor: Sawyer H. TERRELL, San Francisco, CA (US)

(21) Appl. No.: 14/109,853

(22) Filed: Dec. 17, 2013

Related U.S. Application Data
(60) Provisional application No. 61/873,699, filed on Sep. 4, 2013.

(30) Foreign Application Priority Data
Dec. 18, 2012 (GB) 1222835.9

(51) Int. Cl. A01G 25/00

(52) U.S. Cl. CPC A01G 25/00
USPC 239/201

(57) ABSTRACT

It can be seen that a need arises for irrigation systems, or devices suitable for providing outlets from irrigation systems, that enable effective spray over a plurality of areas, to include sloping regions.

Accordingly the present invention provides an irrigation device for connection to an irrigation system, comprising: a base for connecting said device to said system to allow though-passage of liquid, said base cooperating with a body to direct exit of said liquid through a head; wherein arrangement of said head controls exit of the liquid with respect to a first axis, and arrangement of said body controls exit of the liquid with respect to a second axis.

### CROSS REFERENCE TO EARLIER APPLICATIONS

This application claims priority under 35 U.S.C. §119 to GB patent application no. 1222835.9 filed Dec. 18, 2012, the disclosure of which is incorporated herein by reference in its entirety.

This application claims the benefit of 35 U.S.C. §119 U.S. Provisional Application No. 61/873,699, filed Sep. 4, 2013, the disclosure of which is incorporated by reference herein in its entirety.

### FIELD OF THE INVENTION

The present invention relates to an irrigation device, more particularly an irrigation device for use with an irrigation or sprinkler system.

### BACKGROUND

In light of increasingly variable climate conditions, and increasing awareness of value of vegetation, many users wish to irrigate, spray or sprinkle produce, grass or crops with water or liquid such as containing chemicals, in an attempt to hydrate or manage said vegetation.

A problem encountered by many of said users is that given increasingly rare resources, in particular land and water resources, many plots of vegetation, lawns or greens, are on far from planar land, and often may include sloping regions and generally variable irrigation requirements.

It can therefore be seen that a need arises for irrigation systems or devices suitable for providing outlets from irrigation systems that enable effective spray over a plurality of areas, to include sloping regions.

### SUMMARY OF THE INVENTION

According to the present invention there is provided an irrigation device for connection to an irrigation system, comprising: a base for connecting said device to said system to allow though-passage of liquid, said base cooperating with a body to direct exit of said liquid through a head; wherein arrangement of said head controls exit of the liquid with respect to a first axis, and arrangement of said body controls exit of the liquid with respect to a second axis.

Typically the irrigation system is buried in the ground and comprises pipework for supplying water, although embodiments may be envisaged above ground wherein said system comprises a hose.

Such a system in either eventuality acts to direct or spray water or liquid from a remote location for use local to the device, and wherein the area local to the device is sloped, angled or otherwise difficult to irrigate with conventional means, and wherein ideally obstacles may be avoided in addition or the alternative.

Said device is typically envisaged to be fixed, at least in use, at a fixed point with reference to the system or more particularly system outlet.

Typically the base, body and head are substantially coaxially arranged sequentially following an outlet from said system.

The base is advantageously provided with a seal in use between the system or system outlet and device so as to ensure no liquid is lost or misdirected. Said seal may comprise a screwthreaded, clipped or separately fastened connection between the base and system, in some embodiments cooperating with a rubber, silicone or otherwise resiliently deformable elastomer ring or part arranged to deform on or during screwing or fastening of the base into the system outlet or system.

In preferred embodiments movement or arrangement of the body with reference to the base directs passage of liquid along a first and substantially vertically defined axis, so as to exit the head in a spray at variable heights, and arrangement of said head directs or causes passage of the liquid to exit the head at points or an arc defined along a substantially horizontally described second arcuate axis.

In this way the body is altered or adjusted to raise or lower the spray, and the head may be altered to widen or narrow the spray, and a user is enabled to adjust along said first axis to control distance and height of spray and adjust along said second axis to control breadth of spray. Combination of adjustment therefore enables large variation in effective spray coverage in relation to the fixed point.

In some embodiments rotation of the body in relation to the base or base in relation to the system outlet may be envisaged whereas in other embodiments amendment or replacement of the head also enables plural circumferential spray directions, either in use or through predefinition.

Preferably the movement and/or amendment of the body and head may be achieved simultaneously, sequentially or in cooperation.

In order to aid in achieving amendment along the first axis, the body in preferred embodiments pivots or hinges on or about the base, wherein spray is directable along the first axis and the body is capable of movement along said first axis without affecting or displacing the base, and consequently without affecting the seal, and typically wherein a part of the body is fixed or rotates about the base.

Preferably the base thereby includes a pivot, wherein the body engages with the pivot typically on two opposing sides of the base and body.

In preferred embodiments pivoting about the pivot may be limited, prevented, constrained or incremental, for example wherein the pivot may comprise incremental step pivoting which requires further action to authorise such as vertical displacement or ¼ turn screwthread or mutually engaging and disengaging parts; and/or wherein the pivot is provided with a lock.

For example a lock may be provided to prevent undesired movement of the pivot, or more particularly undesirable movement of the body on the base. Said lock may be comprised by any reversible mechanism but typically comprises at least one grub screw.

Typically the body, base or head comprises or includes an internal liquid connector through which the liquid passes from the base to the head. Said connector is ideally located in the body or base wherein it is preferable that the head is removable, detachable or displaceable, and ideally without disturbing the connector.

In preferred embodiments advantageously said liquid connector is wholly or at least partially formed of resiliently deformable material so as to allow flexure during pivoting of the body with reference to the base. For example therefore said liquid connector is continuous in use within and through the body, to proximate the head, and is sealed to the base, for example by the body, and is advantageously unaffected by relative orientation, disposition or movement of the base and head.

Therefore the connector advantageously allows maintenance of uninterrupted flow of liquid regardless of arrangement.

The liquid connector is therefore formed at least in part of silicone, rubber or elastomer and is tubular, contains a through passage, or is otherwise substantially or wholly hollow.

In some preferred embodiments the connector contains internal structure for example bracing, wherein said bracing is formed of analogous material and permits the connector to resist outward deformation under pressure from the liquid in the system.

It may also be advantageously envisaged that in preferred embodiments the liquid passes from or through the connector into a channel or chamber in the base, body or head, wherein said channel or chamber is proximate or precedent to the head.

Said chamber or channel is ideally formed so as to permit directed, contained and easily adjustable through-flow.

Consequently an adjustment mechanism may allow alteration or amendment of the pressure and flow rate of liquid from the system, through the device and eventually through the head, by adjustment of sizing of the channel or chamber.

For example the body or head may be adjusted by an adjustment mechanism that allows relative movement of the head and body with reference to the base, or the body with reference to the base, or the head with reference to the body, or wherein base, body or head are urged towards the system outlet so as to limit flow by decreasing size of the chamber or channel.

In some preferred embodiments the body may be screwed into the base, or the head screwed into the body, in order to simply and effectively restrict passage of liquid through said channel or chamber, and into and out of the head, by decreasing the size or volume of the channel or chamber and accordingly increasing relative pressure of the liquid so as to create longer distance of spray and lesser volume.

In order to allow restriction or expansion of the chamber or channel in some embodiments the body and base for example may include varying or variant facing planes, surfaces or cones, for example a Venturi, wherein coaxial movement towards or away along the axis may effect pressure and flow changes.

Ideally said screwing may be finalised or more particularly the passage of liquid may be blocked in such fashion so as to prevent passage of liquid from the system, for example during maintenance, or clement conditions.

In some embodiments the adjustment mechanism may be consolidated by, or operative with, a secondary consolidation mechanism wherein unauthorised or undesirable unscrewing and adjustment is minimised.

For example in some embodiments said consolidation mechanism comprises a fastener, for example a screw so as to fix the adjustment mechanism or more particularly fix adjustment of the head in relation to the body.

For example said consolidation mechanism may comprise the aforementioned grub screw(s), relating contemporaneously or simultaneously to prevention of rotation of the pivot.

In order to amend spray along the second axis the head in preferred embodiments comprises an open segment or lacuna for passage of liquid, wherein the head may be defined by a typically circular or annular disc top in preferred embodiments with an otherwise continuous closed side or sides, wherein said side includes at least one open segment, arc or lacuna which allows exit of liquid and wherein the side or sides is/are also provided with an attachment or closure to prevent exit or passage of liquid and spray.

Said attachment or closure may comprise the majority or minority of the side or sides and may be continuous for example wherein the lacuna is formed integral to or intermediate the side(s).

In some embodiments the lacuna may be closed by a flap or displaceable part wherein the lacuna may be covered to prevent spray.

In further embodiments a plurality of lacunae or holes may be provided in said side, such as spaced apart along the side circumference, for example in order to allow multi-directional spray from multiple points about the circumference or periphery of the head.

Ideally said head is detachable without affecting or adjusting or displacing the body and base, in order that the first axis may remain fixed as defined.

In preferred embodiments in order to effect closure and/or attachment the head clips, tolerance, interference or friction fits onto the body, for example to include mutually engaging male and female parts, wherein advantageously the male part is provided on an inner face of the head or side and the female part on an outer face of the body, for example comprising projections or a lip or ridge extending about or around the body.

In this way the head may be fitted to the body without alteration of or interference with the adjustment mechanism, wherein for example the body may be used without addition or restriction of a head in some embodiments.

In some embodiments the head and body include an engagement mechanism such as screwthreading, a ¼ screw turn engagement or slot and nub engagement. Said engagement mechanism may combine with a resiliently deformable or sprung member which requires displacement in addition or subsequent to turning.

In further embodiments pressure on the head, such as may be occasioned through passage of liquid from the body or pressure of liquid from the body, is used or envisaged to consolidate or maintain the head in place in use, for example whereby the head is provided with male parts that engage with a ridge or female parts in an engagement plane orthogonal to a direction in which the head is urged by liquid in the body, for example wherein the head is screwed onto the body or part of the body.

In preferred embodiments the body is split into two portions, wherein the head attaches to one portion and may be moved relative to the other, and wherein the portions may be moved with respect to each other in order to adjust flow and adjust the channel or chamber.

Advantageously in preferred embodiments the head may be removed from the body and replaced repeatedly in order to allow multiple head styles or dispositions. Ideally therefore attachment of the head to the body is temporary and reversible, but capable of preventing unauthorised passage or exit of liquid or spray.

In some embodiments the head may be amended, adjusted or altered in use, for example wherein parts or all of the head may be rotated in respect of the body so as to open or close the segment and allow greater or lesser quantities of liquid to pass through.

In some further embodiments parts may be turned in relation to other relatively fixed parts, wherein for example a first part may be fixed to the body and a second part mounted thereon, such that segments or arcs may be opened or closed without replacement of the head.

### BRIEF DESCRIPTION OF THE DRAWINGS

FIG. 1 shows an isometric view of a preferred embodiment of the device;

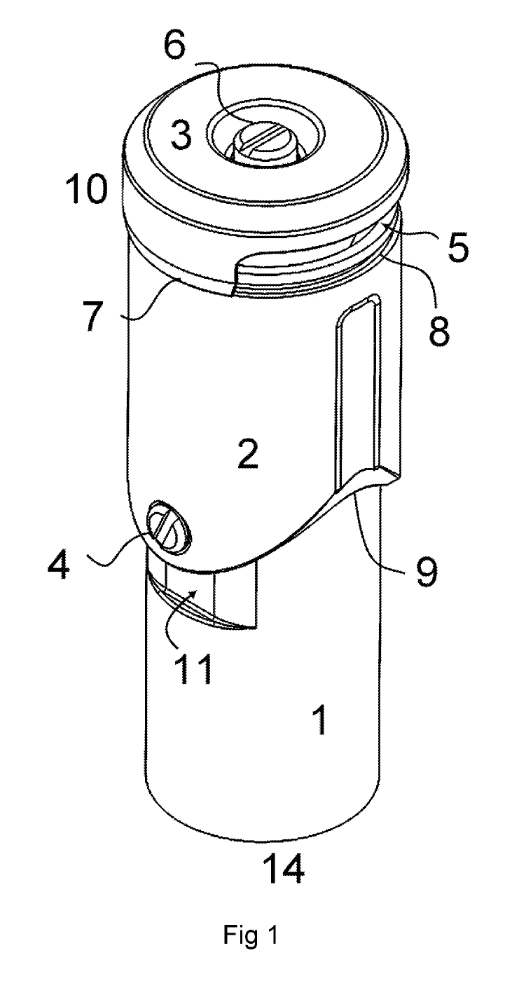

FIG. 2 shows a side view of the embodiment shown in FIG. 1, with body pivoted on the base;

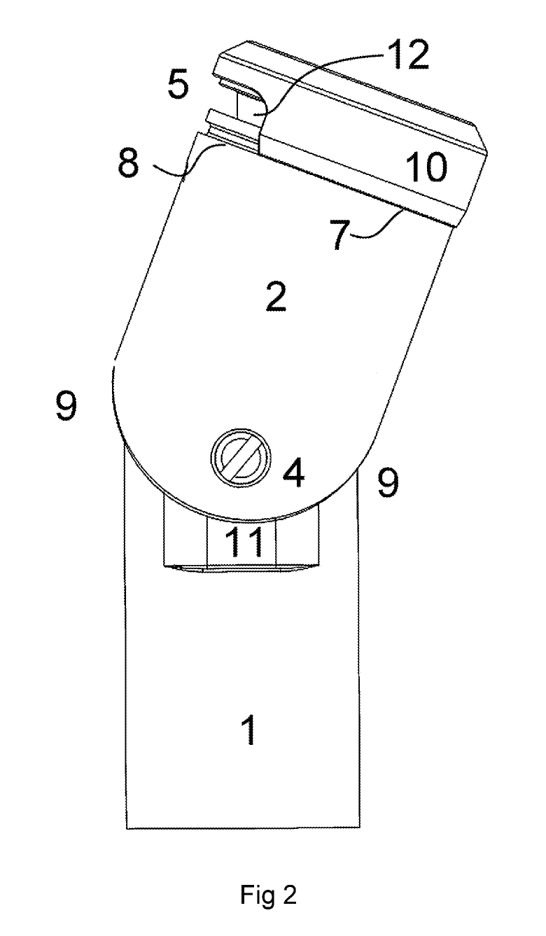

FIG. 3 shows a view from in front of the embodiment shown in FIG. 1;

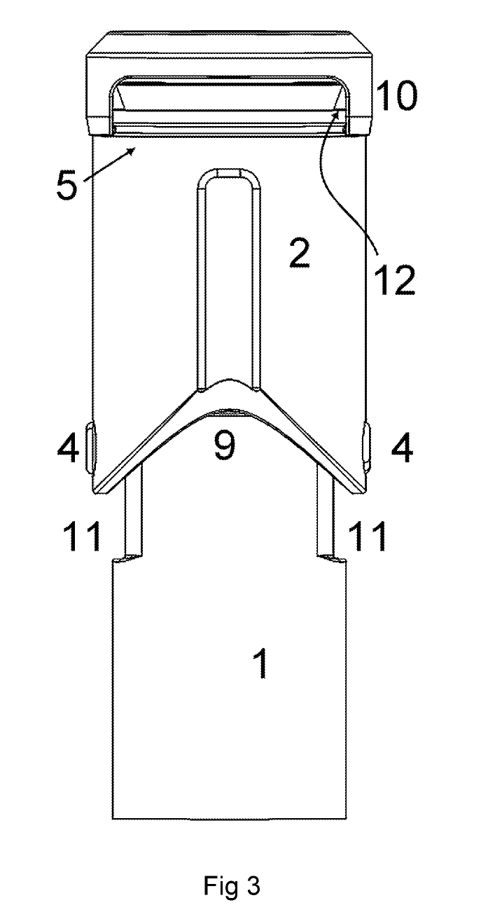

FIG. 4 shows a side view of the embodiment shown in FIG. 1;

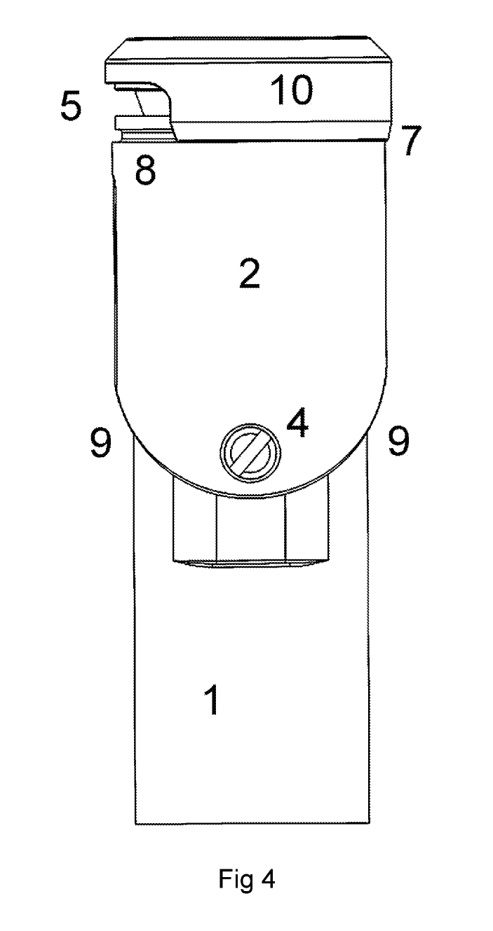

FIG. 5 shows a view from the rear of the embodiment shown in FIG. 1;

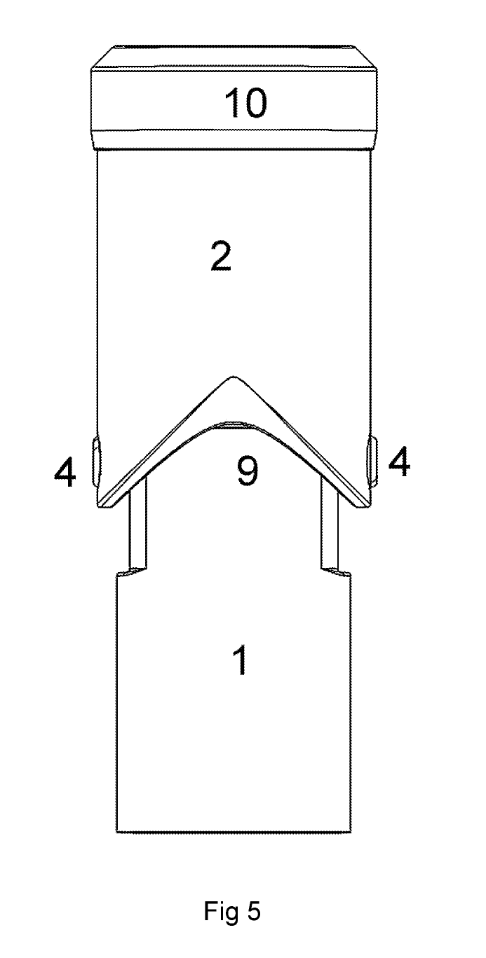

FIGS. 6A and 6B show end views of the embodiment shown in FIG. 1;

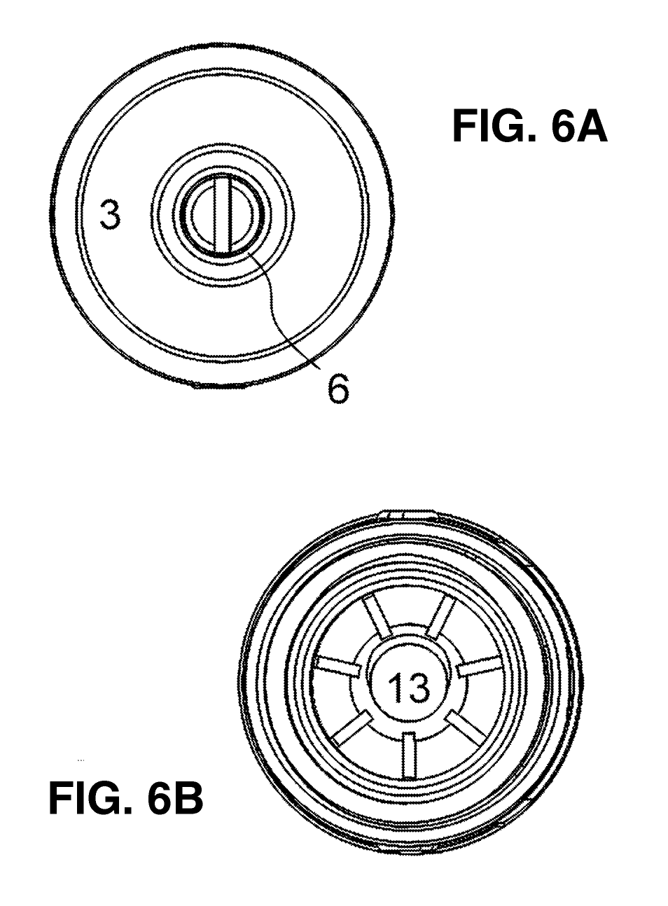

And

FIG. 7 shows an exploded isometric view of the embodiment shown in FIG. 1.

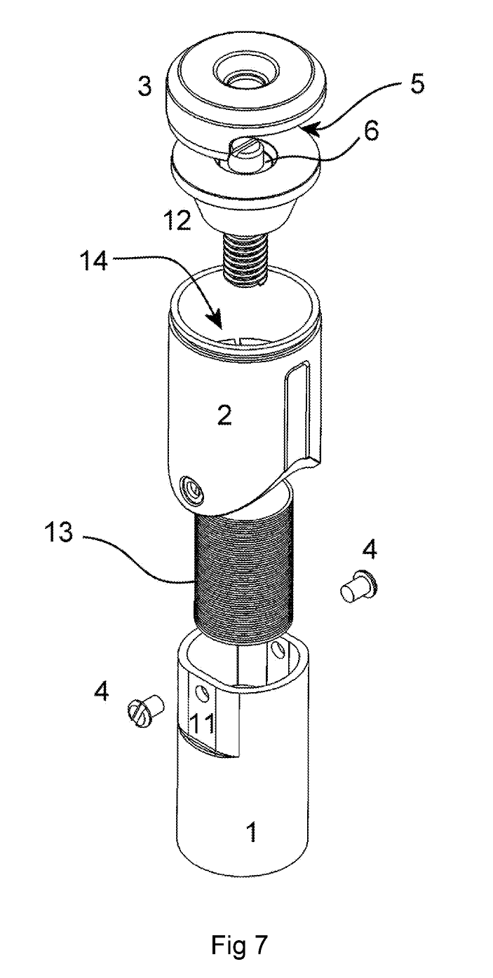

### DETAILED DESCRIPTION

With reference to the figures therefore the base 1 is a cylindrical tube with an open end 14 for attachment to the system and a body 2 pivoted at pivots 4, wherein the base 1 includes indentations 11 in which the body 2 may move when pivoted.

The body 2 also includes arcuate sides 9 enabled substantial pivoting and a lock comprising two grub screws 4. Said grub screws are formed in stainless steel and said body and base in synthetic plastic, so as to minimise water damage.

The body 2 supports a head 3, wherein said head 3 is secured to the body by resiliently deformable lip 7 on the head 3 clipped over a ridge 8 in use, around a majority of the side 10. Said ridge in some embodiments is resiliently deformable wherein the side 10 and lip 7 are strengthened to resist pressure from liquid from the system. Said side 10 leaves a segment 5 open for passage or exit of liquid or spray.

The adjustment mechanism for adjustment of pressure is comprised by a screw set 6 which acts to screw the body 2 into or out of the base 1, and along the indentations 11, and consequently alters flow through the segment 5.

The body is therefore comprised of two coaxial portions namely a lower outer body 2 and a smaller inner body 12, wherein mutual movement of the portions 2, 12 together or apart along the axis, as defined by the screw set 6, alters the shape of an internal channel or chamber and wherein liquid passes through the connector 13 apertures 14 in the lower body 2 into the chamber against the upper body 12 and out of the segment 5.

The body contains a resiliently deformable, flexible or elastic connector 13, which allows movement and more particularly pivoting of the lower body portion 2 with respect to the base 1.

The invention has been described by way of examples only and it will be appreciated that variation may be made to the above-mentioned embodiments without departing from the scope of invention.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, suitable modifications and equivalents may be resorted to, falling within the scope of the invention.

1. An irrigation device for connection to an irrigation system, the irrigation device comprising:
a base for connecting said device to said system to allow though-passage of liquid, said base cooperating with a body to direct exit of said liquid through a head;
wherein the body comprises an internal liquid connector through which the liquid passes from the base to the head;
wherein said connector comprises resiliently deformable material;
wherein arrangement of said head controls exit of the liquid with respect to a first axis; and
wherein arrangement of said body controls exit of the liquid with respect to a second axis.

2. A device according to claim 1 wherein the irrigation system is buried in the ground and comprises pipework for supplying water.

3. A device according to claim 1 wherein the irrigation system is above ground and comprises a hose.

4. A device according to claim 1 wherein the base, body and head are substantially coaxially arranged sequentially following an outlet from said system.

5. A device according to claim 1 wherein the axes are substantially orthogonal.

6. A device according to claim 1 wherein the body pivots or hinges on or about the base.

7. A device according to claim 6 wherein a lock prevents undesired movement of the pivot.

8. (canceled)

9. (canceled)

10. A device according to claim 1 wherein an adjustment mechanism allows amendment of pressure and flow-rate of liquid from the system through relative adjustment of the body and base.

11. (canceled)

12. (canceled)

13. An irrigation device for connection to an irrigation system, the irrigation device comprising:
a base for connecting said device to said system to allow though-passage of liquid, said base cooperating with a body to direct exit of said liquid through a head;
wherein the body comprises an internal liquid connector through which the liquid passes from the base to the head;
wherein said connector comprises resiliently deformable material;
wherein arrangement of said head controls exit of the liquid with respect to a first axis;
wherein arrangement of said body controls exit of the liquid with respect to a second axis; and
wherein the base, body and head are substantially coaxially arranged sequentially following an outlet from said system.

14. A device according to claim 13 wherein the irrigation system is buried in the ground and comprises pipework for supplying water.

15. device according to claim 13 wherein the irrigation system is above ground wherein said system comprises a hose.

16. A device according to claim 13 wherein the axes are substantially orthogonal.

17. A device according to claim 13 wherein the body pivots or hinges on or about the base.

18. A device according to claim 17 wherein a lock prevents undesired movement of the pivot.

19. A device according to claim 13 wherein an adjustment mechanism allows amendment of pressure and flow-rate of liquid from the system through relative adjustment of the body and base.
